(19) United States
(12) Patent Application Publication
(10) Pub. No.: US 2006/0189330 A1
(43) Pub. Date: Aug. 24, 2006

(54) Method for presentation of multiple graphical displays in operations support systems

(76) Inventors: Ellen Maureen Nelson, Laporte, CO (US); Bruce Votipka, Fort Collins, CO (US); Craig A. Ehike, Ft. Collins, CO (US)

Correspondence Address: AGILENT TECHNOLOGIES, INC.;INTELLECTUAL PROPERTY ADMINISTRATION, LEGAL DEPT., M/S DU404, P.O. BOX 7599, LOVELAND, CO, 80537-0599, US

(21) Appl. No.: 11/045,820

(22) Filed: Jan. 28, 2005

(51) Int. Cl. H04Q 7/20

(52) U.S. Cl. 455/457

(57) ABSTRACT

Method and apparatus for presenting data in an operations support system. In one illustrative embodiment, a user is present with a list of aspects of a network for which graphical displays are available and allowed to select an aspect for which a graphical display is desired. A default graphic is displayed based on the users selection. Thereafter, when the user performs a predetermined process, a list of available alternative graphic types and or related data sources is displayed based on the data used to generate the graphic. When the user selects an alternative graphic and or related data set from the displayed list, displaying another graphic based on the user's selection.

### BACKGROUND OF THE INVENTION

The term Operations Support System (OSS) generally refers to a system (or systems) that performs management, inventory, engineering, planning, and repair functions for communications service providers and their networks. Originally, OSS's were mainframe-based, stand-alone systems designed to support telephone company staff members in their daily jobs by automating manual processes, making operation of the network more error-free and efficient. Today's OSS's manage an increasingly complex set of products and services in a dynamic, competitive marketplace helping service providers maximize their return on investment (ROI) in one of their key assets-information. The ultimate goal of OSS's is to enable service providers to reduce costs, provide superior customer service, and accelerate their time to market for new products and services.

OSS's, such as the AGILENT QoS Manager, model the topography of the system under test and collect a variety of data describing the state of and activity on the system under test. Data can be gathered from individual applications, servers, network links and networking equipment. In general, the data comprises a stream of scalar values which are stored and analyzed by the OSS's. The values are used to produce graphics describing the operation of the system under test. Such graphics may include graphs and charts, from which a trained user may assess end-to-end service performance. For example, displays may be formulated that provide an indication of whether the service provider is adhering to service level agreements with subscribers.

Taking the AGILENT QOS MANAGER as an example, displays of data usually take the form of a graph or chart. Some examples include, line graph, bar chart, stacked bar chart, health, and histograms (usually presented as a bar chart). Navigation through the various displays is usually facilitated using a graphical interface comprising a hierarchical tree that models the services provided by the network under test. Organization of the tree may be based on the type of measurement, the type of service or the piece of equipment being monitored or some combination thereof. The user navigates the tree structure and selects an aspect of a network to be displayed.

For example. a user may select a server on a top level of the hierarchial tree and be presented with several selectable categories, for example Web Services; TopN Critical Test; and Service Level Agreement Test. If the user selects the Web Services node, he may be asked to select from a set of sub-nodes, for example: Service Metrics; Http Servers; and TopN Response Time. Under the Service Metrics node a set of nodes that bring up graphs that provide indications of the availability of the system, for example Http Availability and Http Total Response Time.

In the past, the type of graph displayed is pre-determined for a particular display node on the tree. Thus, there was no easy way to generate a different type of graph for the same data. Further, known systems limit the types of graphs based on the type of measurement semantic. For example, measurement values are only displayed as measurement values; state information is only displayed as state values; and TopN measurement data is only displayed as TopN measurement data. No known system permits a user to display collected data in a different form other than the default forms. For example, no mechanism exists to permit a user to view a measurement data as health states. Similarly, no mechanism exists to permit a user to easily switch between related graphs, such as parent nodes, child nodes, or underlying data without navigating the tree structure.

Accordingly, the present inventors have recognized a need for new methods for permitting a user to view measurement data in multiple forms using a simple navigation process.

### BRIEF DESCRIPTION OF THE DRAWINGS

An understanding of some embodiments of the present invention can be gained from the following detailed description, taken in conjunction with the accompanying drawings of which:

FIG. 1 is a block diagram of network.

FIG. 2 is a flow chart of a method in accordance with an embodiment of the present invention.

FIG. 3 is a flow chart of a method in accordance with an embodiment of the present invention.

FIG. 4 is a flow chart of a method in accordance with an embodiment of the present invention.

FIG. 5 is a representation of a display in accordance with an embodiment of the present invention.

FIG. 6 is a representation of a display in accordance with an embodiment of the present invention.

FIG. 7 is a representation of a display in accordance with an embodiment of the present invention.

FIG. 8 is a representation of a display in accordance with an embodiment of the present invention.

FIG. 9 is a representation of a display in accordance with an embodiment of the present invention.

FIG. 10 is a representation of a display in accordance with an embodiment of the present invention.

FIGS. 11a, 11b, and 11c are representations of displays in accordance with an embodiment of the present invention.

### DETAILED DESCRIPTION

Reference will now be made in detail to embodiments of the present invention, examples of which are illustrated in the accompanying drawings, wherein like reference numerals refer to like elements throughout. The detailed description which follows presents methods that may be embodied by routines and symbolic representations of operations of data bits within a computer readable medium, associated processors, general purpose personal computers and the like. These descriptions and representations are the means used by those skilled in the art effectively convey the substance of their work to others skilled in the art.

A method is here, and generally, conceived to be a sequence of steps or actions leading to a desired result, and as such, encompasses such terms of art as “routine,” “program,” “objects,” “functions,” “subroutines,” and “procedures.” The methods recited herein may operate on a general purpose computer or other network device selectively activated or reconfigured by a routine stored in the computer and interface with the necessary signal processing capabilities. More to the point, the methods presented herein are not inherently related to any particular device; rather, various devices may be used to implement the claimed methods. Machines useful for implementation of the described embodiments of the present invention include those manufactured by such companies as AGILENT TECHNOLOGIES, INC. and HEWLETT PACKARD, as well as other manufacturers of computer and network equipment.

With respect to the software described herein, those of ordinary skill in the art will recognize that there exist a variety of platforms and languages for creating software for performing the methods outlined herein. The described embodiments of the present invention can be implemented using any of a number of varieties of JAVA, however, those of ordinary skill in the art also recognize that the choice of the exact platform and language is often dictated by the specifics of the actual system constructed, such that what may work for one type of system may not be efficient on another system. It should also be understood that the methods described herein are not limited to being executed as software on a microprocessor, but can also be implemented in other types of processors. For example, the methods could be implemented with HDL (Hardware Design Language) in an ASIC (application specific integrated circuits).

TopN measurements, as discussed herein, are described in co-pending United States Patent Application XX/XXX,XXX, entitled: METHOD FOR IMPLEMENTING TOPN MEASUREMENTS IN OPERATIONS SUPPORT SYSTEMS, filed on the same day as the present application and assigned to the same assignee. The 'XXX application is incorporated herein by reference.

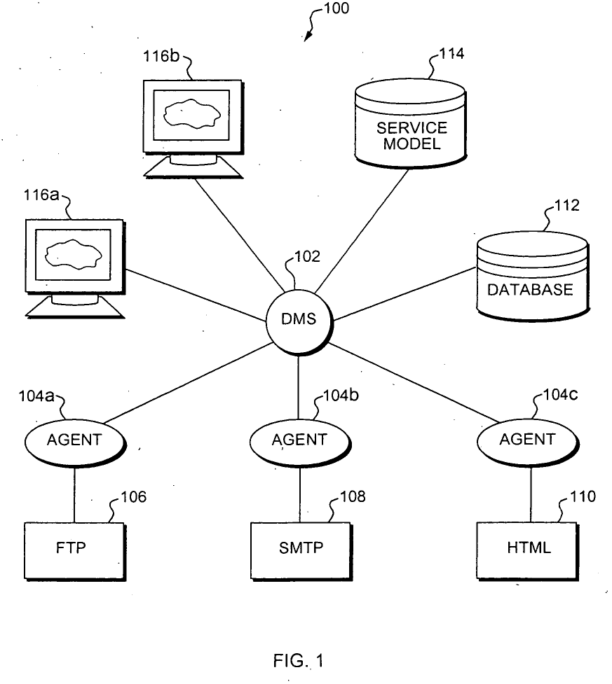

FIG. 1 is a block diagram of an OSS system 100 upon which the described embodiments of the present invention may be practiced. More specifically, the OSS system 100 is based upon the commercially available AGILENT QOS MANAGER OSS 5.5.0 (referred to hereinafter as the AGILENT system). General operation of the AGILENT system is presented in the AGILENT OSS QOS MANAGER 5.5.0 CONCEPTS GUIDE (part number 5188-3724, published July 2004) incorporated herein by reference. It is to be recognized that the OSS system 100 is but one example of an OSS upon which the present invention may be implemented. Further, while the following description will adopt the nomenclature of the AGILENT system, this in no way is intended to limit the present invention to the AGILENT system, rather the present invention is system independent.

The core of the OSS 100 is one or more diagnostic measurement servers (DMS) 102. The primary function of the DMS 102 is to manage and analyze data collected by agents 104n. Some of the typical functions of the DMS 102, include: storing and maintaining all measurement data; calculating baseline and thresholds; determining the health of elements of the system under test; implementing actions when a threshold is exceeded or a health state changes; and configuring agents.

The agents 104n are responsible for running test, collecting measurements and forwarding measurement data to the DMS 102. Typically, at least one agent 104n is installed on the DMS 102. Other agents 104n may be installed on elements of the system under test, such as an FTP server 106, and SMTP server 108, and a HTML server 110. Agents 104n run independent of the DMS 102, in other words the availability of the DMS 102 does not affect the operation of the Agents 104n. Agents 104n are configured to interact with the elements they are to measure, for example agent 104b will use simple mail transfer protocol to communicate with SMTP server 108.

The DMS 102 utilizes the service model 114 to identify elements of the system under test. The service model 114 integrates elements of the system under test into a hierarchical tree structure that permits the visualization of elements and their interdependencies. The service model is more fully explained in U.S. Pat. No. 6,336,138, entitled Template-Driven Approach For Generating Models of Network Services, issued Jan. 1, 2002 and incorporated herein by reference. The DMS 102 stores information, including measurements, in at least one database, such as the database 112. The database could, for example, comprise an ORACLE database.

Graphical user interfaces 116n interact with the DMS 102 to provide a user with displays that facilitate interaction with the DMS 102 and agents 104n. Functions of the user interface include building and managing the service model 114; defining thresholds; defining event triggers; viewing events, and viewing graphs, reports, and service level compliance agreements.

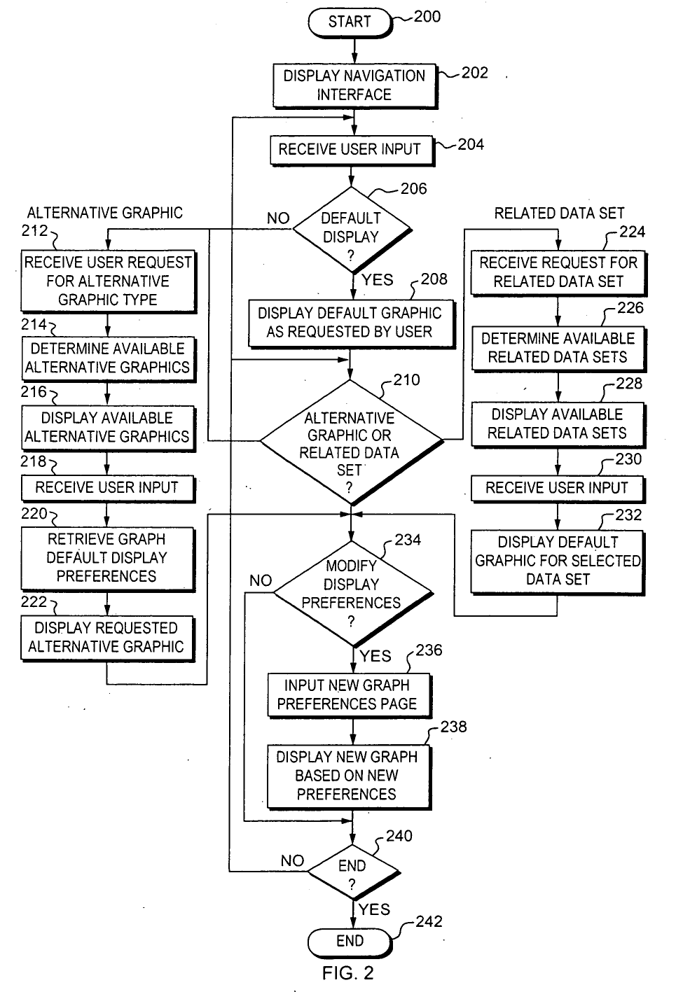

FIG. 2 is a flow chart of a method in accordance with an embodiment of the present invention. The method starts in step 200. In step 202, a navigation interface is displayed. One suitable navigation interface is a tree display similar to that provided in WINDOWS EXPLORER. In a tree display, items are arranged in a hierarchical node structure with sub-nodes being hidden until a parent node is activated. Organization of the nodes may be by any convenient structure. Taking AGILENT'S QOS MANAGER as an example, nodes may be organized by service. Top-level nodes are typically organized by services, such as web service, mail services, ect. . . . Sub-nodes under the service nodes typically include a service metrics node and one or more server nodes. Sub-nodes of the overall service metrics node typically include aggregated measurements which may be associated with service level agreement compliance. The server nodes collect servers associated with the overall service. The sub-nodes associated with each individual server node represent the different collections of information describing the performance of the individual server. U.S. Pat. No. 6,336,138, incorporated herein by reference, describes apparatus and methods used to generate a service model suitable for display using a tree structure as the navigation interface described in step 202.

Next, in step 204, user input is received indicating a selection, e.g. a node, on the navigation interface for which a graphical display is desired. In step 206 a determination is made as to whether the user has requested an alternative graphics display or whether the default graphics is acceptable. Generally, by left clicking on a node the user signifies that the default graphic is acceptable. Right clicking on a node will present the user with a pop-up menu related to alternative graphics (discussed with respect to steps 212 through 222).

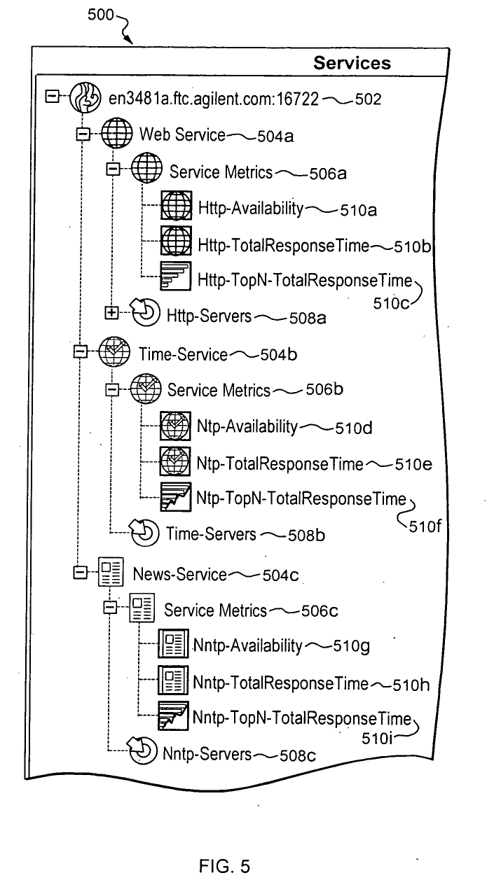

Assuming that the default graphic was selected, the method proceeds to step 208 and a default graphical display is generated based on default preferences associated with the selected node. Preferences include: time frame to be displayed; time intervals; whether to display thresholds; whether to display baselines; preferences related to grid lines (thickness, scale, etc. . . . ); preferences related to legends (font, size, placement, ect. . . . ); and preferences related to labels (font, size, placement, ect. . . . ). The Examples of displays may be found in FIGS. 5 though 11 and will be discussed in more detail hereinbelow.

In step 210 a determination is made as to whether the user desires to see the data presented in an alternative graphic or view a graphic illustrating data related to the current data set. In the first instance, the method proceeds to step 212 where the request to view the data using a different graphic is recognized. In the second instance, the method proceeds to step 224 where the request to view a graphic for a related data set is recognized. If neither an alternative graphic nor a related data set is desired, the method proceeds to step 234.

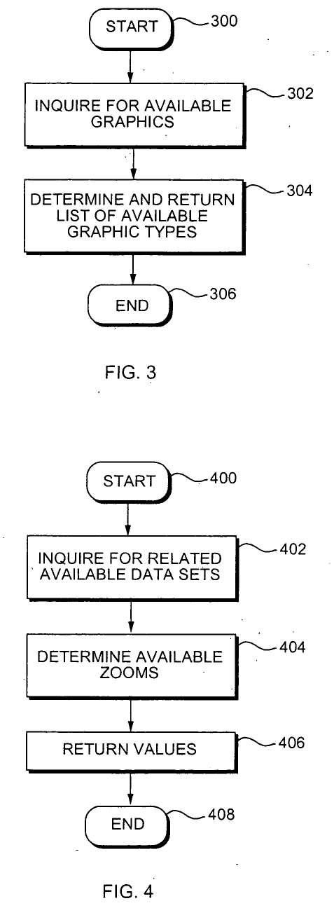

If an alternative graphic display is desired, in either step 206 or 210, the method proceeds to step 212, where the request is received. This generally comprises a right click on the node for which an alternative display is requested. If a default display has already been completed, this may comprise a right click on the default graphic. It is to be noted that various methods exists to facilitate the indication that some action is required and that such methods vary with the operating system. Once the request has been received, the method proceeds to step 214 where a determination is made as to what alternative graphics are available. This determination is more fully discussed with respect to FIG. 3.

In step 216, a display is generated providing the user with indications of what alternative graphics are available. It may prove preferable to provide generic graphical representations of the available types of alternative graphics. It is envisioned that alternative graphics generally comprise different graph types. For example, if the default graph is a measurement graph, e.g. a series of values plotted over time, alternative graphs may include: a health graph (wherein the health state of the node is indicated for each time period, typically using green, yellow, and red icons); a histogram; a geographical representation; tables of data and a time series, etc. . . . It is to be understood that other types of displays may be provided as options to the user, such as the textual display of the data from which the graphs are derived.

Next in step 218, the user selects an alternative graph to display. In step 220, the default display preferences are retrieved for the selected graph type. As noted above the display preferences may include, for example: time frame to be displayed; time intervals; whether to display thresholds; whether to display baselines; preferences related to grid lines (thickness, scale, etc. . . . ); preferences related to legends (font, size, placement, ect. . . . ); and preferences related to labels (font, size, placement, ect. . . . ). Subsequently, in step 222, the alternative graphic is displayed using the default preferences. The method then proceeds to step 234.

If in step 210, the creation of a display of a related data set is requested, the method proceeds to step 224, where the request is received. This generally comprises a right click on the element on the graph for which an alternative display is requested. It may also comprise a right click on a selected node. It is to be noted that various methods exists to facilitate the indication that some action is required and that such methods vary with the operating system. Once the request has been received, the method proceeds to step 226 where a determination is made as to what alternative data sets are available. This determination is more fully discussed with respect to FIG. 4.

Related data sets include: data sets from the same source over a different time period; data underlying an aggregated data point (such as a Top N value); data referenced by a parent node in the service model; data referenced by a child node in the service model; information about the node being viewed; and navigation information linking to external data (such as a database or web site related in some manner to the selected node). It may also prove useful to consider alternative graphics as a related data set and integrate them into the available options.

Once the available related data sets have been identified, they are displayed to the user. In this case it may prove preferable to simply provide a textual list of the possibilities—although graphical representations, such as icons can certainly be used. In step 230, the user selects which related data set he wishes to view. In step 232, the default graphic for the selected data is generated. The method then proceeds to step 234.

In step 234, a determination is made as to whether the user desires to change the display preferences. If such changes are desired, the method proceeds to step 236 where the user indicates which display preferences to change. In step 238, a new display is created based on the changed preferences.

Once the new graph has been display, or if no changes are required in step 234, the method proceed to step 240 where a check is made as to whether the user wishes to exit the method. If an exit is desired, the method ends in step 242, otherwise a return is made to step 210 or step 204.

FIG. 3 is a flow chart of a method in accordance with an embodiment of the present invention. More specifically, the method shown in FIG. 3 is suitable for implementation as step 214 in FIG. 2. The method starts in step 300. In step 302, an inquiry is issued to identify available alternative graphics. In the system shown in FIG. 1, such an inquiry could be directed from a GUI 116n to a DMS 102. In step 304, a determination is made as to the available graphic types and a corresponding list is returned. The DMS 102 may generate information providing alternative graphic types in a variety of maners. In one example, the information is stored as part of the service model 114. In this instance, each node would maintain a list of graphic display that are possible with data encapsulated by that node. Such a list may also include indications of the various routines to be called to produce the listed graphic displays. In another example, the DMS 102 may maintain a table, for example in the database 112, that provides corresponding available graphic displays for each node type, e.g. intermediate, measurement or TopN. By way of example, a TopN node may support four graph types: health; measurement; histogram; and time series. By way of another example, a measurement node may support two graph types: health and measurement. Intermediate nodes, i.e. nodes with sub-nodes, may only support one graph type: health.

FIG. 4 is a flow chart of a method in accordance with an embodiment of the present invention. More specifically, the method shown in FIG. 4 is suitable for implementation as step 226 in FIG. 2. The method starts in step 400. In step 402, an inquiry is issued to identify available related data sets. In the system shown in FIG. 1, such an inquiry could be directed from a GUI 116n to the service model 114 via the DMS 102. Related data sets include the existence of a parent or child node, data underlying an aggregated value, navigation information, information about the node, and alternative displays.

In step 404, available zooms are identified. Generally, zoom levels are identified by routines associated with the GUI 116n based on a current zoom level. As used herein, the term zoom generally refers to the time period associated with the displayed graphic, e.g. 1 hour, 1 day, 1 week . . . Thus, if an entire data set from a 1 day block was currently displayed, there might exist the possibility for two levels of zoom—1 hour and 1 week.

In step 406, indications of the available related data sets are returned, e.g. to the GUI 116n.

FIGS. 5 through 11 provide illustrations of various graphical displays associated with methods described in FIGS. 2 through 4. In particular, FIGS. 5 through 11 are based on displays generated by AGILENT's QOS MANAGER. The described embodiments of the present invention may be practiced on most, if not all OSS systems, the AGILENT system being but one example.

FIG. 5 is a representation of a display in accordance with an embodiment of the present invention. In particular FIG. 5 illustrates one possible configuration of navigation mechanism 500 for an OSS. The navigation mechanism 500 corresponds to the service model used by the AGILENT QOS SERVICE MANAGER 5.5.0. Those of ordinary skill in the art will recognize that other navigation mechanisms may be utilized. In FIG. 5, the navigation mechanism 500 generally comprises a tree structure with a plurality of hierarchically organized nodes. A top node 502, encapsulates the services offered on the en3281a.ftc.Agilent.com system. Three intermediate nodes 504n represent services offered—node 504a represents the web services; node 504b represents the time services; and node 504c represents the news services.

Under each service node 504n, two additional intermediate nodes 506n and 508n represent collections of measurements related to service metrics (506n) and the actual servers related to the services (508n). Measurement nodes 51 On under the intermediate nodes (only nodes 506n being shown as expanded) represent various measurements, each with an associated default graphic display, available for viewing. Three types of measurements are shown, as examples, for each expanded branch: Availability; Total Response Time; and TopN Total Response Time.

Further details of the navigation mechanism illustrated in FIG. 5 may be found in the AGILENT OSS QOS MANAGER 5.5.0 CONCEPTS GUIDE (part number 5188-3724, published July 2004) incorporated herein by reference.

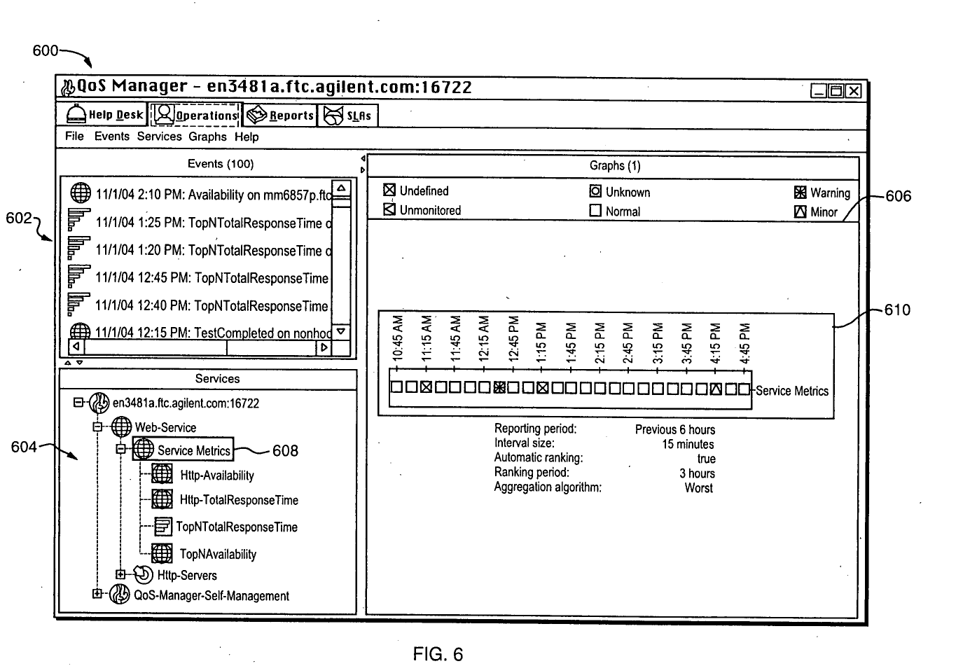

FIG. 6 is a representation of a display 600 in accordance with an embodiment of the present invention. The display 600 is basically divided into three sections: an events section 602; the navigation mechanism 604; and the graphical display section 606. The events section 602 lists events as they occur. Events typically comprise some measured value exceeding a preset threshold. Events may, for example, be detected by the DMS 102 with notification to the GUI 116n. The navigation mechanism 604 presents a graphical display of the service model 114 and may correspond to the display illustrated in FIG. 5. The graphical display section 606 shows a graphical display associated with a selected event or node. In general, when a node is selected, a default graph for that node is displayed, as described in FIG. 2. The user may request alternative graphic or graphics of a related data set (as also described with respect to FIG. 2).

In FIG. 6, the user has selected an intermediate node 608 (not a measurement node) in the navigation mechanism 604, resulting in a graph 610 of the current health status values to be displayed in the graphical display 606. The graph displayed is the default graph type for the clicked-on node, a typical health graph, of health statuses over a time period. With respect to FIG. 2, the display shown in FIG. 6 corresponds to step 208. A health graph displays a series of icons, each indicating the health state of a node at a particular time. In the example shown in FIG. 6, the icon is a colored square. A green square corresponds to a healthy system while yellow and red may indicate a minor and a major warning respectively. Additional colors may be used to indicate undefined or unknown states or that the node was unmonitored during that time period.

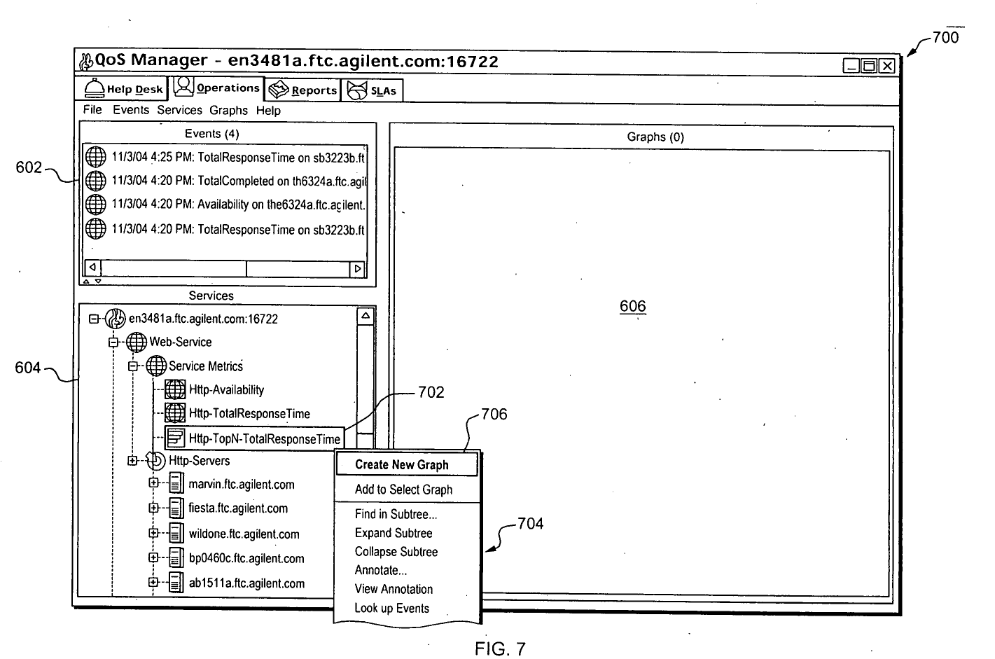

FIG. 7 is a representation of a display 700 in accordance with an embodiment of the present invention. In FIG. 7, the user has right-clicked on a TopN measurement node 702 in the navigation mechanism 604 to bring up a pop-up menu 704. In turn the user has selected the “Create New Graph” menu item 706. With respect to FIG. 2, the display corresponds to step 212 (as arrived at from steps 202 or 210). Once selected, the system will determine the available alternative graphics and provide the user with a choice of graph types that are available from the clicked-on node.

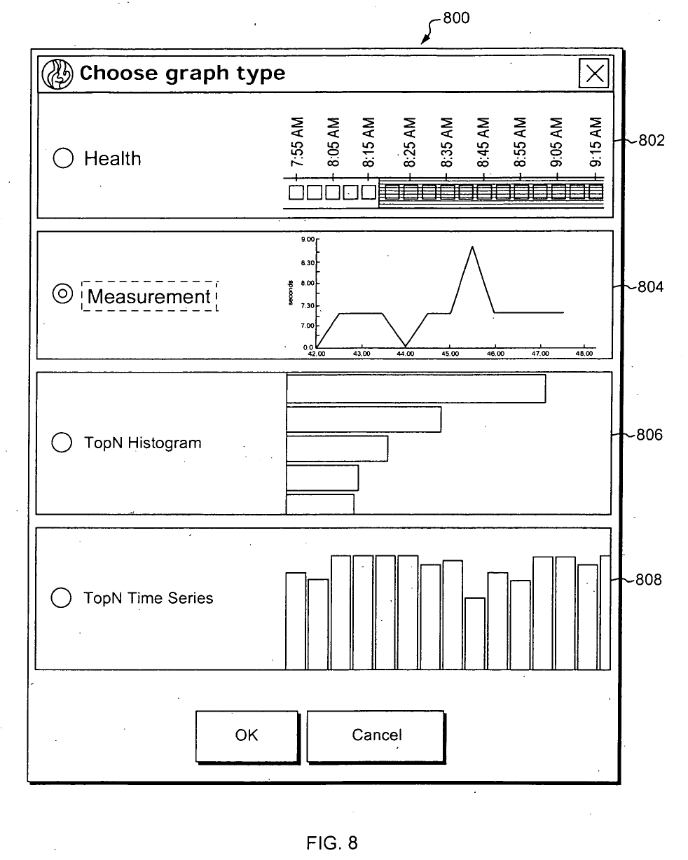

FIG. 8 is a representation of a display 800 in accordance with an embodiment of the present invention. The display 800 pops up when the user selects the “Create New Graph” menu item 706. In this case, the selected node was a TopN measurement node, resulting in the user being presented with four types of alternative graphics: a health graph 802; a measurement graph 804; a histogram 806; and a time series 808. In this case the user has selected the measurement graph 804. Measurement graphs plot values over time and typically comprise either a line graph or a bar graph. With respect to FIG. 2, the display corresponds to steps 214 through 218.

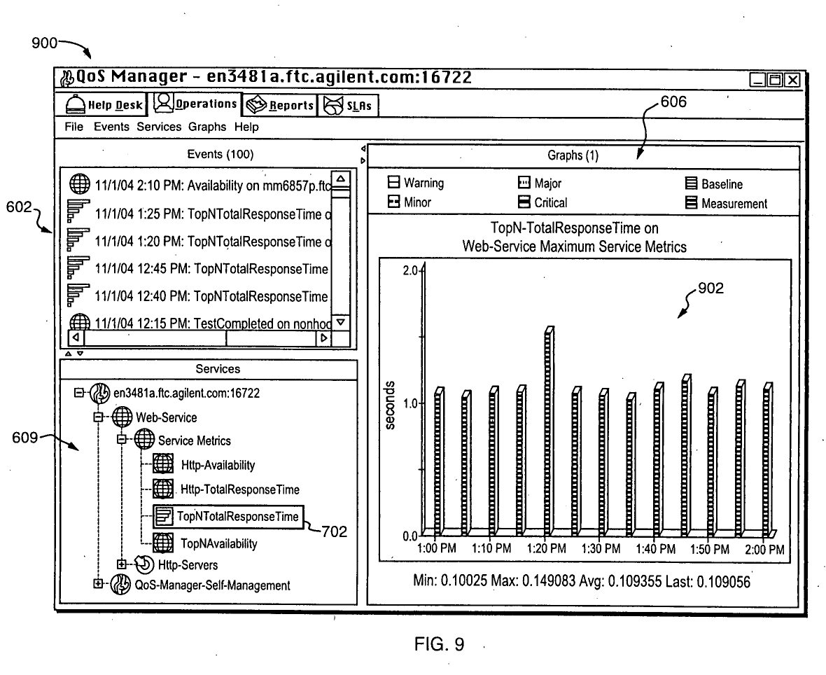

FIG. 9 is a representation of a display 900 in accordance with an embodiment of the present invention. The display 900 includes a measurement graph 902 corresponding to the node 702. In this case, as the selected node is a TopN measurement node, the measurement graph will plot a representative value for each TopN object over a period of time. Further discussion of TopN objects may be found in co-pending United States Application # xx/xxx,xxx incorporated herein by reference. With respect to FIG. 2, the display corresponds to step 220 and 222.

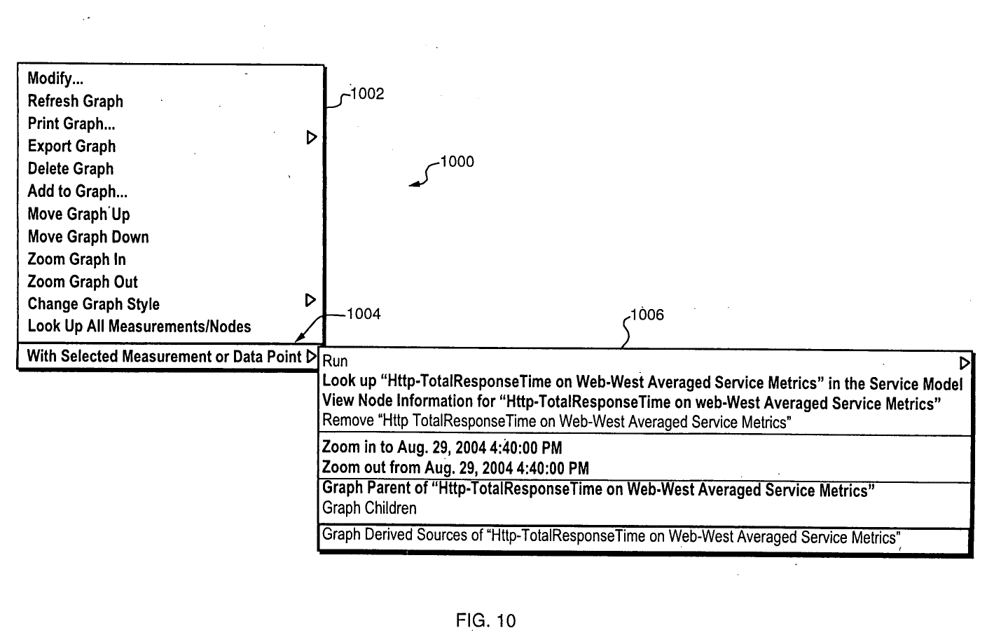

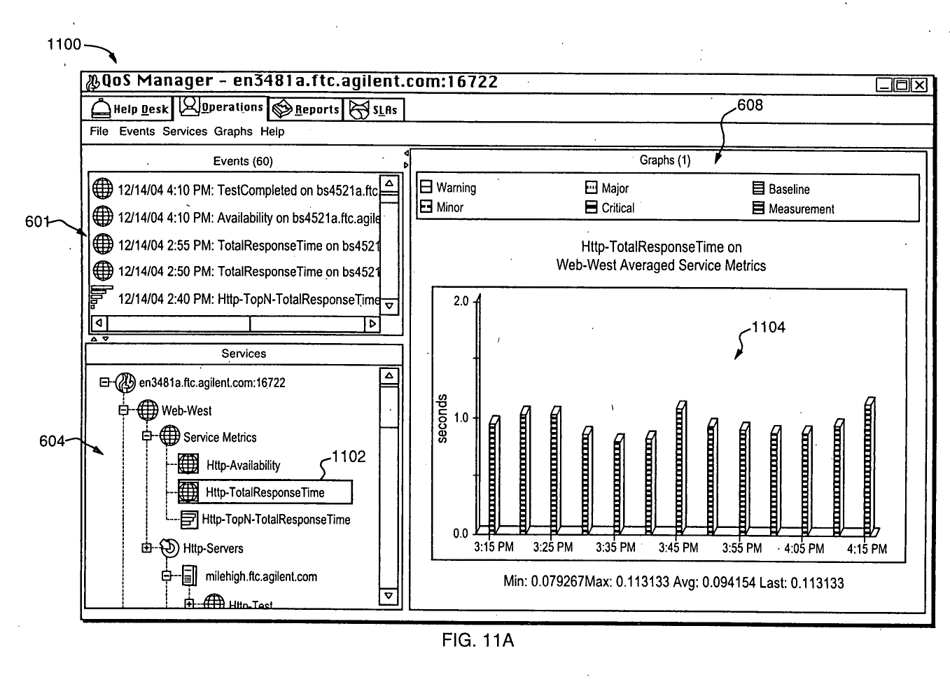

FIG. 10 is a representation of a display 1000 in accordance with an embodiment of the present invention. The display 1000 comprises a pop-up menu 1002 that is displayed when the user right clicks on a measurement point in a displayed graph. This corresponds to step 224 (as arrived at via step 210) in FIG. 2. In addition to other options, the user is supplied with entry 1004 “with selected Measurement Node or Data Point” which further pops-up menu 1006. Menu 1006 facilitates the selection of a graphic representing a related data set.

The menu 1006 provides several related data sources, including options facilitating: looking up the node in the service model; retrieving node information from the service model; zooming (in and out); pulling up graphics associated with parent and child nodes; and graphing derived sources (individual sources of data underlying an aggregated data point). With respect to FIG. 2, the display corresponds to step 228 (with input derived from step 226).

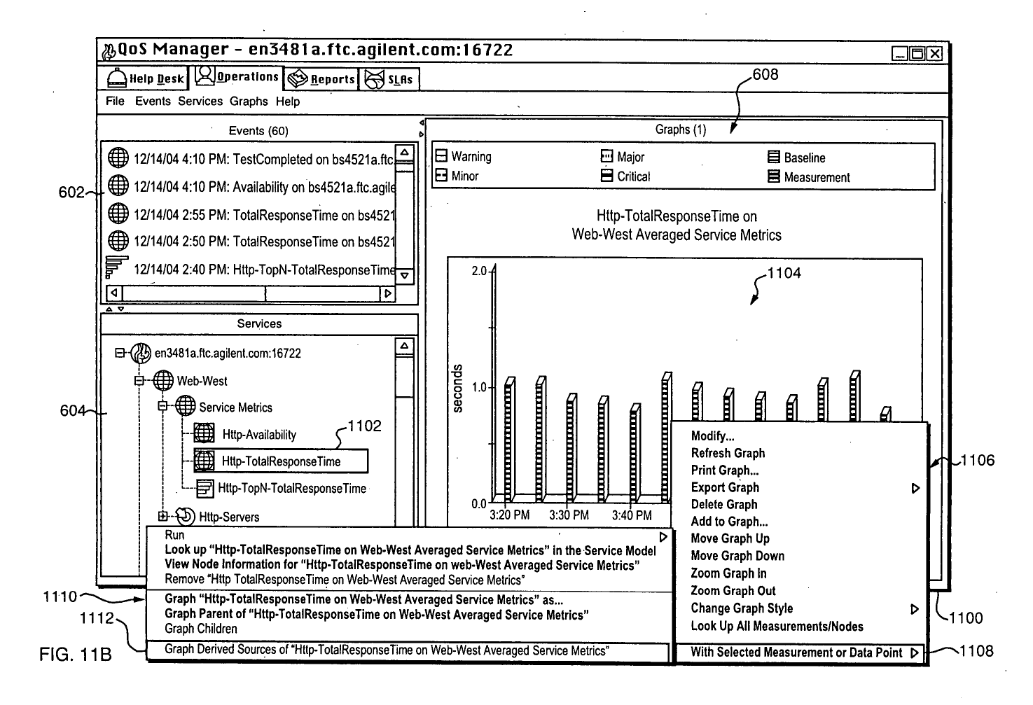

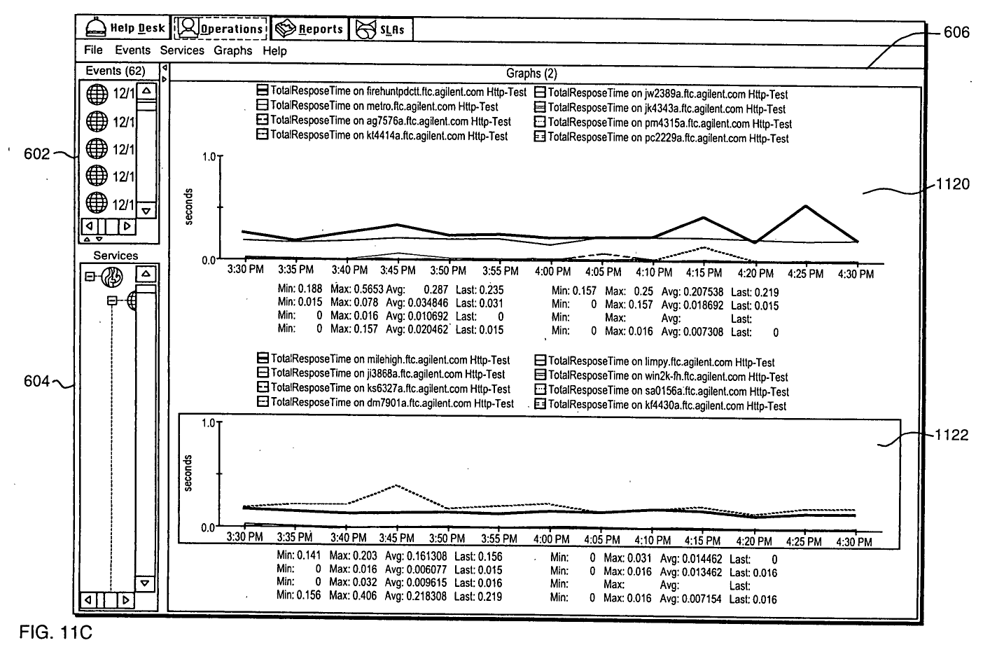

FIGS. 11a, 11b, and 11c are representations of displays in accordance with an embodiment of the present invention. The displays illustrated in FIGS. 11a, 11b, and 11c illustrate a progression from a default graph to a graph of derived sources. In FIG. 11a, a default graph of an aggregate measurement (derived from other measurements) is presented. The user has selected the Http-TotalResponseTime node 1102 from the navigation mechanism 604. This has resulted in a measurement graph 1104 where each bar represents aggregated response times of a variety of HTTP servers at that particular point. In FIG. 11b, the user has right clicked on a measurement point (a bar) in the graph 1104 producing menu 1106. From menu 1106, the user has selected item 1108: “With Selected Measurement or Data Point” causing sub-menu 1110 to pop up. The user then selected item 1112: “Graph Derived Sources of Http-TotalResponseTime on Web-West Averaged Service Metrics.” This selection will create as many graphs as required to display the response times from each of the servers underlying the aggregated measurement. FIG. 11c illustrates two measurement graphs 1120 and 1122 that detail the response time on each of the servers represented by the node 1102 in the navigation mechanism 604. In this case, each graph illustrates eight different servers, for a total of 16 servers.

Although some embodiments of the present invention have been shown and described, it will be appreciated by those skilled in the art that changes may be made in these embodiments without departing from the principles and spirit of the invention, the scope of which is defined in the claims and their equivalents.

What is claimed is:

1. A method of presenting data in an operations support system, the method comprising:
presenting a user with a list of aspects of a network for which graphical displays are available;
allowing a user to select an aspect for which a graphical display is desired;
displaying a default graph based on the users selection;
when the user performs a predetermined process, displaying a list of alternative graph types for the type of data used to generate the graph; and
when the user selects an alternative graph type from the displayed list, displaying the alternative graph type.

2. The method, as set forth in claim 1, wherein the step of presenting a user with a list of aspects comprises:
creating a navigational display organized by service, with indications of the aspects of a network for which graphical displays are available.

3. The method, as set forth in claim 2, wherein the predetermined process comprises right clicking a previously selected indication.

4. The method, as set forth in claim 1, further comprising:
when the user performs a second predetermined process, displaying a list of related graphs based on data related to the data used to generate the default graph; and
when the user selects a-related graph from the displayed list, displaying the related graph.

5. The method, as set forth in claim 4, wherein the second predetermined process comprises right clicking an element on the currently displayed graph.

6. A method of presenting data in an operations support system, the method comprising:
presenting a user with a list of aspects of a network for which graphical displays are available;
allowing a user to select an aspect for which a graphical display is desired;
displaying a default graph based on the users selection;
when the user performs a predetermined process, displaying a list of related graphs based on data related to the data used to generate the default graph; and
when the user selects an related graph from the displayed list, displaying the related graph.

7. The method, as set forth in claim 6, wherein the step of presenting a user with a list of aspects comprises:
creating a navigational display organized by service, with selectable indications of the aspects of a network for which graphical displays are available.

8. The method, as set forth in claim 7, wherein the predetermined process comprises right clicking a previously selected indication.

9. The method, as set forth in claim 6, further comprising:
when the user performs a second predetermined process, displaying a list of alternative graph types for the type of data used to generate the graph; and
when the user selects an alternative graph type from the displayed list, displaying the alternative graph type.

10. The method, as set forth in claim 9, wherein the second predetermined process comprises right clicking on the currently displayed graph.

11. A method of presenting graphical data to a user of an OSS, the method comprising:
accepting a users selection of an aspect of a system under test;
displaying a graphic associated with the users selection;
determining alternative graphics which may be created based on the selected aspect of the system;
displaying to the user a list of alternative graphics associated with the selected aspect of the system; and
displaying an alternative graphic selected by the user.

12. A method, as set forth in claim 11, wherein the alternative graphics include alternative graphs types valid for the type of data underlying the selected aspect of the system.

13. A method, as set forth in claim 11, wherein the alternative graphics include graphics of data related to the data underlying the selected aspect of the system.

14. A method, as set forth in claim 13, wherein the aspects of the system are related hierarchically in a service model and the related data includes data associated with parent or children nodes of the selected aspect.

15. A system for displaying graphics related to a network under test, the system comprising:
at least one agent that measures values related to a system under test; and
a graphical user interface configured to:
accepting a users selection of-an aspect of the network under test;
displaying a graphic associated with the users selection;
determining alternative graphics which may be created based on the selected aspect of the network;
displaying to the user a list of alternative graphics associated with the selected aspect of the network; and
displaying an alternative graphic selected by the user.
